(19) United States
(12) Patent Application Publication
(10) Pub. No.: US 2012/0032922 A1
(43) Pub. Date: Feb. 9, 2012

(54) OPTICAL TOUCH SYSTEM

(75) Inventors: Ping-Chung Lin, Taipei City (TW); Chen-Kuan Lin, Fengyuan City (TW); Yi-Chien Lin, Taipei City (TW); Yu-Chen Chen, Xindian City (TW)

(73) Assignee: Quanta Computer Inc., Tao Yuan Shien (TW)

(21) Appl. No.: 12/954,070

(22) Filed: Nov. 24, 2010

(30) Foreign Application Priority Data
Aug. 6, 2010 (TW) 99126384

(51) Int. Cl. G06F 3/042

(52) U.S. Cl. 345/175

(57) ABSTRACT

An optical touch system includes a substrate, at least one sensor, a processing unit and an analysis unit. The substrate has a touch region. The at least one sensor is used for capturing a full-size image of the touch region, wherein the full-size image includes a central region image near a light axis of the at least one sensor, and a side region image. The processing unit is used for sampling the central region image to obtain a central compressed image and transmitting the central compressed image and the side region image under a normal mode. The analysis unit is used for analyzing the central compressed image and the side region image to obtain a touch point coordinate.

This application claims the benefit of Taiwan application Serial No. 99126384, filed Aug. 6, 2010, the subject matter of which is incorporated herein by reference.

### BACKGROUND OF THE INVENTION

1. Field of the Invention

The invention relates in general to an optical touch system, and more particularly to an optical touch system with variable resolution levels.

2. Description of the Related Art

The touch screen which provides an instinctive way of operation has now been widely used in various electronic products, such as portable electronic device, desktop computer or ATM. According to the principles of sensing, the touch screen can be divided into resistive touch screen, capacitive touch screen, ultra-sonic touch screen and optical touch screen. Let the optical touch screen be taken for example. When an object such as the user's finger or a stylus is placed in the touch region, the light emitted from the light source will be blocked by the object. Based on the image received by the sensor, the touch point coordinate of the object in the touch region can thus be obtained.

However, as the technology advances, the resolution level expected of the touch screen is getting higher and higher. A high-resolution touch screen has a large number of pixels, and the computational burden required to obtain the touch point coordinate increases several times. Thus, the overall system will be overloaded with computation, and the cost will increase accordingly. Therefore, how to optimize the overall optical touch system to increase the overall efficiency and effectively control the cost has become an imminent task to the industry.

### SUMMARY OF THE INVENTION

The invention is directed to an optical touch system, which applies different levels of magnification to the regions with different levels of optical distortion, so as to optimize the efficiency of the overall optical touch system.

According to a first aspect of the present invention, an optical touch system including a substrate, at least one sensor, a processing unit and an analysis unit is provided. The substrate has a touch region. The at least one sensor is used for capturing a full-size image of the touch region, wherein the full-size image includes a central region image near a light axis of the at least one sensor, and a side region image. The processing unit is used for sampling the central region image to obtain a central compressed image and transmitting the central compressed image and the side region image under a normal mode. The analysis unit is used for analyzing the central compressed image and the side region image to obtain a touch point coordinate.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows an optical touch system according to a preferred embodiment of the invention;

FIG. 2A shows an example of a sensor pixel under a normal mode according to a preferred embodiment of the invention; and

FIG. 2B shows an example of a sensor pixel under a high-resolution mode according to a preferred embodiment of the invention.

### DETAILED DESCRIPTION OF THE INVENTION

The invention provides an optical touch system, which applies different levels of magnification to the regions with different levels of optical distortion, so as to optimize the efficiency of the overall optical touch system.

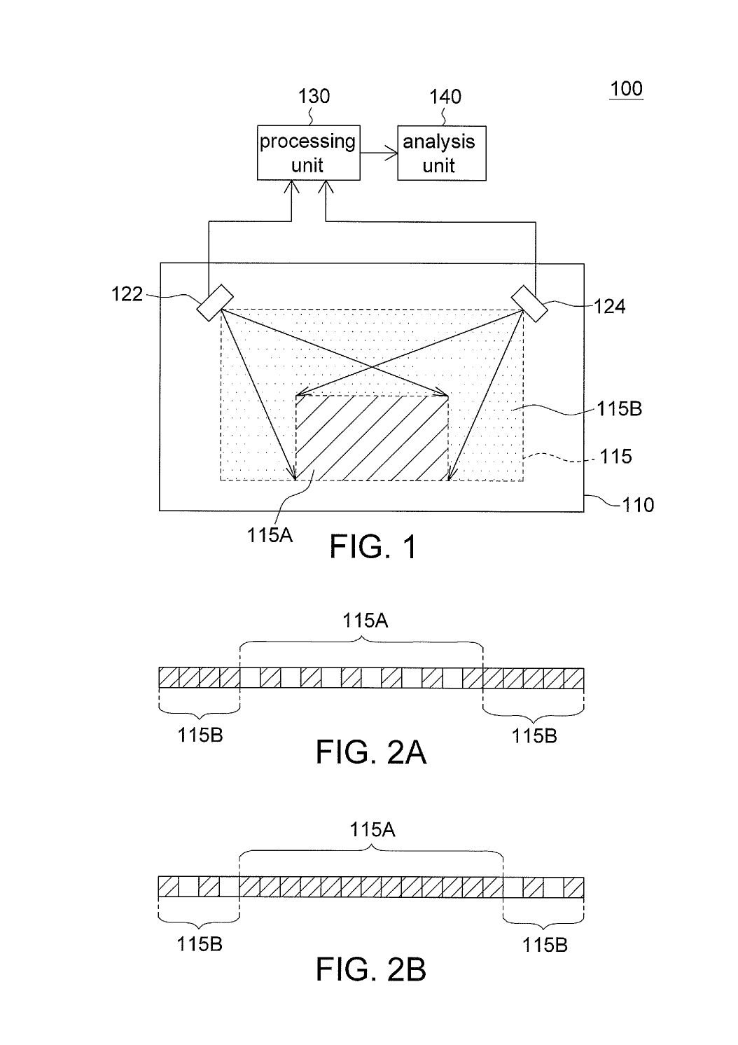

Referring to FIG. 1, an optical touch system according to a preferred embodiment of the invention is shown. The optical touch system 100 includes a substrate 110, two sensors 122 and 124, a processing unit 130 and an analysis unit 140. In the present embodiment of the invention, two sensors 122 and 124 are used for exemplification, but such exemplification is not for limiting the number of the sensor. A touch region 115 can be defined on the substrate 110 by a number of optical elements such as light guide bars and reflectors. The sensing area of the two sensors 122 and 124 at least covers the touch region 115.

The sensors 122 and 124 is used for capturing a full-size image of the touch region 115, wherein the full-size image includes a central region image 115A near a light axis of the sensors 122 and 124, and a side region image 115B. In the sensor, more pixels are disposed in the region near the light axis. Besides, the optical distortion of the side region image 115B away from the light axis is greater than that of the central region image 115A near the light axis. Based on the above optical properties, the central region image 115A and the side region image 115B are processed in different ways in the present embodiment of the invention.

Under a normal mode, the processing unit 130 samples the central region image 115A to obtain a central compressed image and transmits the central compressed image and the side region image 115B to the analysis unit 140. Referring to FIG. 2A, an example of a sensor pixel under a normal mode according to a preferred embodiment of the invention is shown. In FIG. 2A, the central segment of the sensor with a larger number of pixels (higher resolution) corresponds to the central region image 115A, and the two ends of the sensor with a smaller number of pixels (lower resolution) correspond to the side region image 115B.

The normal mode is used in an ordinary operation which can achieve the required accuracy level of touch control (such as 4 mm probe) without employing a large number of pixels. Therefore, the pixels in the central segment of the sensor can be analyzed by the hopscotch method. That is, the processing unit 130 samples the central region image 115A to obtain a central compressed image, wherein, the magnification of the central compressed image is at least 1.5 times greater than that of the side region image 115B. Thus, the data volume of the central compressed image is reduced without affect the subsequent process of image analyzing.

Under the normal mode, the image transmitted to the analysis unit 140 by the processing unit 130 includes a complete side region image 115B and a central compressed image, wherein the central image is obtained by way of sampling with a reduced data volume. Then, the analysis unit 140 can obtain a touch point coordinate by analyzing the central compressed image and the side region image 115B. Since different levels of magnification are applied to the regions with different levels of optical distortion, the computation burden of the overall system is effectively reduced.

When the optical touch system 100 is used in hand writing recognition or drawing, a larger number of pixels are required to achieve the required accuracy level of touch control (such as 2 mm probe). Normally, only the central region image 115A but not the side region image 115B will meet the required accuracy level of touch control. Therefore, under a high-resolution mode, the processing unit 130 samples the side region image 115B to obtain a side compressed image and transmits the central region image 115A and the side compressed image to the analysis unit 140. Referring to FIG. 2B, an example of a sensor pixel under a high-resolution mode according to a preferred embodiment of the invention is shown. In FIG. 2B, the central segment of the sensor with a larger number of pixels (higher resolution) corresponds to the central region image 115A, and the two ends of the sensor with a smaller number of pixels (lower resolution) correspond to the side region image 115B.

Since the side region image 115B cannot meet the required accuracy level of touch control under the high-resolution mode, the pixels of the sides of the sensor can be analyzed by the hopscotch method. That is, the processing unit 130 samples the side region image 115B to obtain a side compressed image. Thus, the data volume of the side compressed image is reduced without affecting the subsequent process of image analyzing. Furthermore, the side region image 115B can even be neglected so that the data volume of the side compressed image is reduced to a minimum.

Under the high-resolution mode, the image transmitted to the analysis unit 140 by the processing unit 130 includes a complete central region image 115A and a side compressed image, wherein the central image is obtained by way of sampling with a reduced data volume. The analysis unit 140 can obtain a touch point coordinate by analyzing the central region image 115A and the side compressed image. If the side region image 115B is neglected, then only the central region image is transmitted to the analysis unit, which accordingly analyzes the central region image to obtain the touch point coordinate. Since different levels of magnification are applied to the regions with different levels of optical distortion, the computation burden of the overall system is effectively reduced.

The optical touch system disclosed in the above embodiments of the invention has many advantages exemplified below:

The optical touch system of the invention applies different levels of magnification are applied to the regions with different levels of optical distortion, and the resolution levels under different modes are adjusted according to the purpose of use, so that the computation burden of the overall system is effectively reduced, and the overall system efficiency is optimized.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical touch system, comprising:
a substrate having a touch region;
at least a sensor used for capturing a full-size image of the touch region, wherein the full-size image comprises a central region image near a light axis of the at least one sensor, and a side region image;
a processing unit used for sampling the central region image to obtain a central compressed image and transmitting the central compressed image and the side region image under a normal mode; and
an analysis unit used for analyzing the central compressed image and the side region image to obtain a touch point coordinate.

2. The optical touch system according to claim 1, wherein the optical distortion of the side region image is greater than the optical distortion of the central region image.

3. The optical touch system according to claim 1, wherein under the normal mode, the magnification of the central compressed image is at least 1.5 times greater than the magnification of the side region image.

4. The optical touch system according to claim 1, wherein under a high-resolution mode, the processing unit further samples the side region image to obtain a side compressed image and transmits the central region image and the side compressed image to the analysis unit, and the analysis unit analyzes the central region image and the side compressed image to obtain the touch point coordinate.

5. The optical touch system according to claim 1, wherein, under the high-resolution mode, the processing unit further neglects the side region image and transmits the central region image to the analysis unit, and the analysis unit analyzes the central region image to obtain the touch point coordinate.
